(19) United States
(12) Patent Application Publication
(10) Pub. No.: US 2009/0238081 A1
(43) Pub. Date: Sep. 24, 2009

(54) NETWORK MANAGEMENT SYSTEM, DATA ACQUISITION APPARATUS, AND METHOD FOR CHECKING OPERATING CONDITIONS OF NODES

(75) Inventor: Yuji MIYATA, Musashino-shi (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION, Tokyo (JP)

(21) Appl. No.: 12/481,246

(22) Filed: Jun. 9, 2009

(30) Foreign Application Priority Data
Jun. 19, 2006 (JP) 2008-160418

(51) Int. Cl. H04L 12/26

(52) U.S. Cl. 370/241

(57) ABSTRACT

Disclosed is a network management system, including: a data acquisition apparatus to receive data sent from each of a plurality of nodes to store at least latest receipt time of the data; and a management apparatus to check an operating condition of each of the nodes based on the latest receipt time stored in the data acquisition apparatus.

### BACKGROUND OF THE INVENTION

1. Field of the Invention

The present invention relates to a network management system, a data acquisition apparatus, and a method for checking operating conditions of nodes.

2. Description of Related Art

In general, a device such as a server should not be out of service during provision of services. In particular, some servers should be in operation 24 hours a day. Conventionally, network management systems for managing operating conditions of such servers have been used.

FIG. 6 shows an explanatory diagram of a conventional network management system 100. The network management system 100 includes IP nodes 111 and 112 such as server devices, a management apparatus 130 which manages an operating condition of each IP node, and a repeater 140 such as a router which intervenes between the management apparatus 130 and each IP node.

The management apparatus 130 is configured to check and manage the operating condition of each IP node through communication in accordance with an ICMP (Internet control message protocol). The management apparatus 130 includes an ICMP monitor functional section 131 and an ICMP communication functional section 132. The ICMP monitor functional section 131 controls the ICMP communication functional section 132 to perform ICMP communication individually with each IP node.

Because the communication between the management apparatus 130 and each IP node is unicast communication, the number of IP nodes corresponds to the number of ICMP packets to be sent and received. With this communication, processing load of the repeater 140 increases in proportion to the number of IP nodes. The number of IP nodes may be very large according to a size of the system. For example, several tens of thousands of IP nodes may be provided. A repeater provided in such a system is priced prohibitively high. In addition, as ICMP packets, which are not associated with the services provided by the IP nodes, increase, a large number of network resources maybe allocated for the purposes other than the services, which may cause a slow response in the services and a reduction in quality. Such a problem occurs in not only the ICMP but also in all the communications for monitoring the operating condition of each IP node in the network management system.

For this reason, a technique for reducing consumption of network resources in communications for managing operating conditions of nodes has been proposed. For example, JP-A No. 2006-332787 discloses that a network management system causes each node to notify the operating condition using token ring method.

Unfortunately, the network management system disclosed in JP-A No. 2006-332787 requests a reply from each node with respect to the operating condition. Such a request results in significant consumption of processing power of each device in communication for managing the operating condition of each mode. Accordingly, it may be difficult to greatly reduce consumption of resources associated with the management of the operating condition of each node.

### SUMMARY OF THE INVENTION

It is, therefore, a main object of the present invention to reduce consumption of resources associated with management of operating conditions of nodes.

According to a first aspect of the present invention, there is provided a network management system, including: a data acquisition apparatus to receive data sent from each of a plurality of nodes to store at least latest receipt time of the data; and a management apparatus to check an operating condition of each of the nodes based on the latest receipt time stored in the data acquisition apparatus.

According to a second aspect of the present invention, there is provided a data acquisition apparatus which is to be connected to a plurality of nodes and a management apparatus that checks an operating condition of each of the nodes, the data acquisition apparatus, including: a transceiver to receive at least data sent from each of the nodes; a storage unit to store at least latest receipt time of the data sent from each of the nodes; and a control unit to respond to a query from the management apparatus for checking an operating condition of a specified at least one of the plurality of nodes, based on the latest receipt time corresponding to the specified at least one of the plurality of nodes.

According to a third aspect of the present invention, there is provided a method for checking an operating condition of each of a plurality of nodes, the method including: receiving, by a data acquisition apparatus, data sent from each of the plurality of nodes to store at least latest receipt time of the data in the data acquisition apparatus; and checking, by a management apparatus, the operating condition of each of the nodes, based on the latest receipt time stored in the data acquisition apparatus.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram illustrating a configuration of an exemplary network management system according to preferred embodiments of the present invention;

FIG. 2 shows an explanatory diagram of an exemplary last communication time table;

FIG. 3 shows an explanatory diagram of an exemplary IP node alive monitoring probe correspondence table;

FIG. 4 shows an explanatory diagram of an exemplary packet of a request in accordance with an SNMP protocol;

FIG. 5 shows a timing diagram illustrating an alive monitoring operation of each IP node in the network management system; and

FIG. 6 shows an explanatory diagram of a conventional network management system.

### DESCRIPTION OF THE PREFERRED EMBODIMENTS

### (Configuration)

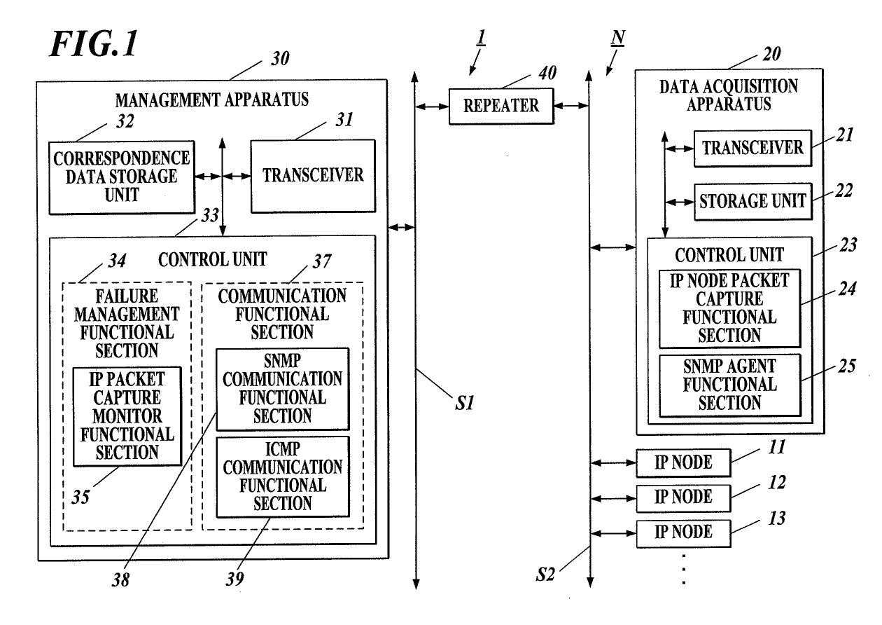

Reference will now be made in detail to one or more exemplary embodiments of the present invention as illustrated in FIGS. 1 to 5.

FIG. 1 is a block diagram illustrating a configuration of an exemplary network management system 1 according to the embodiments of the present invention. As shown in FIG. 1, the network management system 1 includes: IP nodes 11, 12, 13, . . . such as server devices; a data acquisition apparatus 20 which functions as an IP node alive monitoring probe for conducting alive monitoring of each IP node by capturing an IP packet (hereinafter, simply referred to as a packet) transmitted from each IP node; a management apparatus 30 having a network management function for checking and managing operating condition of each IP node; and a repeater 40 which intervenes between the management apparatus 30 and each IP node.

“Alive monitoring of IP node” is a process of monitoring whether or not the IP node is in operation in a data transmittable state or a series of processes for the monitoring.

The IP nodes, the data acquisition apparatus 20, the management apparatus 30, and the repeater 40 are connected to each other via a network N. The network N may be a LAN, the Internet, other communication lines, or a combination thereof. The network N may be a wired network, a wireless network, or a combination thereof.

In the embodiment, the management apparatus 30 is connected to a segment S1, and the IP nodes and the data acquisition apparatus 20 are connected to a segment S2. The repeater 40 is interposed between the segment S1 and the segment S2 to connect the segments.

It should be noted that the above-described connection configuration of the network N is exemplary and for illustrative purposes only. For example, three or more segments may be provided, and repeaters such as the repeaters 40 may intervene between the segments to connect the segments. Alternatively, three or more segments may be connected to a single repeater such as the repeater 40. Furthermore, all the other components may be connected to the same segment without the repeater 40.

In the embodiments, Internet Protocol (IP) is used as a communication protocol. However, alterative communication protocols, for example, a privately-defined communication protocol may be used.

Next, reference will be made to a configuration of the network management system 1.

Each of the IP nodes is an IP node terminal such as a server which provides services. The services of each IP node are provided with software processes performed by each IP node and by network communication. The IP nodes are not different from conventional ones, and thus, detailed description thereof is omitted.

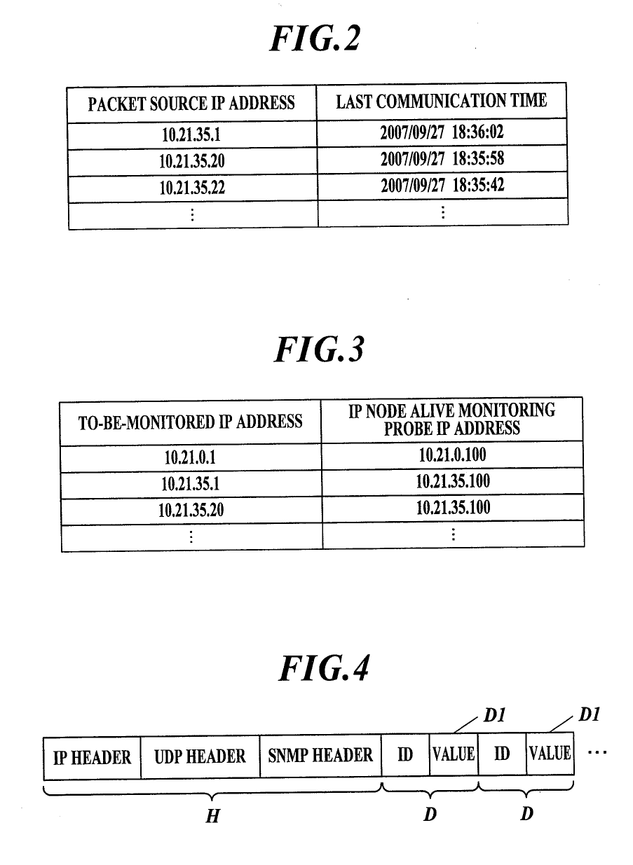

The data acquisition apparatus 20 includes: a transceiver 21 for connecting to the network N; a storage unit 22 for storing a last communication time table T1 (See FIG. 2); and a control unit 23 as “a second control unit” which performs various processes of the corresponding probe. The control unit 23 has at least a packet capture functional section 24 for capturing packets transmitted from each IP node and an SNMP agent functional section 25 for responding to an SNMP communication by the management apparatus 30.

The transceiver 21 is an interface for connecting the network N and has a function of communicating with other connected apparatus. For example, the transceiver 21 may be a network interface card (NIC).

The storage unit 22 is a storage apparatus in which the control unit 23 performs reading and writing operations. For example, the storage unit 22 may be a hard disk drive, a flash ROM, or other rewriteable storage apparatuses.

The control unit 23 is a control apparatus such as a micro-processor. The control unit 23 executes various functions with the corresponding software (not shown). That is, functions of the control unit 23 are executed with software processes.

The IP node packet capture functional section 24 executes a function of receiving a packet transmitted from each IP node and managing a latest receipt time of the packet transmitted from each IP node. The IP node packet capture functional section 24 receives a packet irrespective of whether or not the data acquisition apparatus 20 is a destination of the packet transmitted from each IP node. That is, the IP node packet capture functional section 24 performs IP packet capturing process.

When the packet is received, the IP node packet capture functional section 24 stores a last communication time of the IP node which has transmitted the packet. Updating is performed on the last communication time table T1 stored in the storage unit 22.

FIG. 2 shows an explanatory diagram of an exemplary last communication time table T1. As shown in FIG. 2, the last communication time table T1 is a table-format data having items of a packet source IP address and last communication time.

The packet source IP address corresponds to each IP node which is connected to a segment of the data acquisition apparatus 20 having the last communication time table T1. The number of the IP nodes connected to the segment corresponds to the number of entries of the last communication time table T1.

The last communication time indicates receipt time of a newest packet transmitted from each IP node. When the packet is received, the IP node packet capture functional section 24 sets the last communication time in an entry corresponding to a transmission source IP address of the packet as receipt time of the packet. At this time, if the last communication time is already stored, the last communication time is updated to the receipt time of the newest packet. The receipt time of the packet is acquired from a timer circuit (not shown) which is provided inside or outside the data acquisition apparatus. That is, the last communication time stored in the last communication time table T1 corresponds to the receipt time of the newest packet transmitted from each IP node (the newest receipt time).

In the embodiments, one data acquisition apparatus 20 is connected to one segment, so that the packet capture functional section 24 of the data acquisition apparatus 20 can receive packets transmitted from all the IP nodes which are included in the segment to which the corresponding probe is connected.

Alternatively, a plurality of data acquisition apparatuses 20 may be connected to one segment, so that receiving of the packets from the IP nodes can be divided over the data acquisition apparatuses 20. Furthermore, one data acquisition apparatus 20 may receive packets of the IP nodes included in a plurality of segments.

The SNMP agent functional section 25 executes a function of responding to the SNMP communication by the management apparatus 30. The response will be described later.

The management apparatus 30 includes: a transceiver 31 for connecting to the network N; a correspondence data storage unit 32 for storing an IP node alive monitoring probe correspondence table T2 (See FIG. 3) indicating correspondence between the data acquisition apparatus 20 and an IP node from which the data acquisition apparatus 20 receives data; and a control unit 33 as ‘a first control unit’ which performs various processes of the management apparatus 30.

The control unit 33 has a failure management functional section 34 for conducting alive monitoring of each IP node and a communication functional section 37 for performing communication with each component under the control of the failure management functional section 34.

The failure management functional section 34 has an IP packet capture monitor functional section 35 for conducting alive monitoring of each IP node based on the last communication time of an IC packet captured by the data acquisition apparatus 20 so as to individually conduct the alive monitoring of the IP node which has not transmitted data during a predetermined period of time.

The communication functional section 37 has an SNMP communication functional section 38 which performs communication in accordance with an SNMP protocol and an ICMP communication functional section 39 which performs communication in accordance with an ICMP protocol.

The control unit 33 is a control apparatus such as a micro-processor. The control unit 33 executes various functions with the corresponding software (not shown). That is, functions of the control unit 33 are executed with software processes.

The transceiver 31 is an interface for connecting the network N. For example, an NIC may be employed.

The correspondence data storage unit 32 is a readable storage apparatuses from which the control unit 33 can at least read out data. For example, the correspondence data storage unit 32 may be a hard disk drive, a flash ROM, other rewriteable storage apparatuses, or storage-media (for example, CD-ROM) readable drives.

The correspondence data storage unit 32 stores an IP node alive monitoring probe correspondence table T2.

FIG. 3 shows an explanatory diagram of an exemplary IP node alive monitoring probe correspondence table T2. As shown in FIG. 3, the IP node alive monitoring probe correspondence table T2 is a table-format data having items of a to-be-monitored IP address and an IP node alive monitoring probe IP address.

IP address-format values are stored in entries of the to-be-monitored IP address and the IP node alive monitoring probe IP address. The to-be-monitored IP address in each entry corresponds to one of the IP addresses of the IP nodes. The IP node alive monitoring probe IP address in each entry corresponds to an IP address of the IP alive monitoring probe of the segment to which the IP node corresponding to the entry of the to-be-monitored IP address is connected. For example, a data acquisition apparatus having an IP address associated with the to-be-monitored IP addresses of the IP nodes 11 to 13 in FIG. 1 is the data acquisition apparatus 20. That is, the control unit 33 can specify a data acquisition apparatus which captures an IP packet of an IP node having a to-be-monitored IP address using the to-be-monitored IP address in the IP node alive monitoring probe correspondence table T2 as a table key.

Next, reference will be made below to an alive monitoring operation of each IP node conducted by the IP packet capture monitor functional section 35 of the management apparatus 30.

The IP packet capture monitor functional section 35 performs communication with the data acquisition apparatus 20 according to a predetermined schedule. As a result of the communication, when a notice that an IP node has not performed communication during a predetermined period of time is received, the IP packet capture monitor functional section 35 individually conducts the alive monitoring operation of the IP node.

Communication between the management apparatus 30 and the data acquisition apparatus 20 occurs at regular time intervals. In the communication, the IP packet capture monitor functional section 35 firstly sends a query (request) to the data acquisition apparatus 20 using the SNMP communication functional section 38.

FIG. 4 shows an explanatory diagram of an exemplary packet P1 of a request in accordance with an SNMP protocol. As shown in FIG. 4, a packet P1 has a header H indicating communication in accordance with SNMP protocol and data D for specifying an IP node on which alive monitoring is to be conducted.

The header H includes an IP header, a UDP header, and an SNMP header.

The data D includes an ID having information for specifying an IP node to be requested and a value Dl containing a parameter value of the ID. The ID is a parameter value such as a numerical value corresponding to a to-be-acquired parameter value. For example, the ID is a numerical value such as ‘1.3.6.1.4.1.7427.3.5.1.2.1.1.1.0’ delimited by periods, and data to be requested is specified by the numerical value. The correspondence between the numerical value of the ID and the data to be requested is shared by the SNMP communication functional section 35 of the management apparatus 30 and the SNMP agent functional section 25 of the data acquisition apparatus 20.

The control unit 33 of the management apparatus 30 transmits the packet P1 to the data acquisition apparatus 20 using the SNMP communication functional section 37. At this time, the value D1 is null.

When the packet P1 is received, the control unit 23 of the data acquisition apparatus 20 stores a parameter value corresponding to the ID of the packet P1 into the value D1, and sends a reply to the management apparatus 30 using the SNMP agent functional section 25. That is, the control unit 23 replaces the null value D1 with the parameter value. The packet format of data sent from the data acquisition apparatus 20 to the management apparatus 30 according to the response is the same as that of the packet P1 shown in FIG. 4. The control unit 23 stores the requested data into the value D1 sent as null data as requested, and sends the data to the management apparatus 30.

When the returned packet is received, the management apparatus 30 reads out the parameter value in the value D1 to obtain the data requested by the packet P1.

The data specified by the ID in the packet P1 is last communication time in the last communication time table T1 stored in the storage unit 22 of the data acquisition apparatus 20 which is a destination of the packet P1. The data specified by the ID includes information for specifying the requested IP node. The last communication time of all the IP nodes in the last communication time table T1 may be specified by a single ID. Alternatively, the last communication time of the IP nodes may be individually specified. The correspondence between the ID and the data specified by the ID may be arbitrarily configured. The format of the ID may also be arbitrarily configured.

The control unit 33 reads out the IP node alive monitoring probe correspondence table T2 stored in the correspondence data storage unit 32 in order to associate a data acquisition apparatus as a destination to which the packet P1 is to be transmitted with an IP node which is to be specified in the packet Pi. That is, the management apparatus 30 sends a query to the data acquisition apparatus associated with the IP node on which the alive monitoring is to be conducted.

The control unit 23 of the data acquisition apparatus 2 is requested to obtain last communication time from the last communication time table T1 using ID in the packet P1, and the control unit 23 stores data indicating the last communication time into a value D1 and transmits the data. The query (request) includes information specifying an IP node on which alive monitoring is to be conducted and a value D1 as a null data associated with the information. When the query is received, the control unit 23 replaces the null data with data based on the latest receipt time of the specified IP node to respond to the query.

As shown in FIG. 4, the header H may be followed by data D. In this case, plural types of data may be requested in a single SNMP request. Therefore, for example, if IDs are provided for each IP node, a query for individually specifying a plurality of IP nodes may be sent in a single SNMP request. Alternatively, the data D may be configured to transmit a single packet P1.

In this manner, the control unit 33 of the management apparatus 30 acquires the last communication time of each IP node from which the data acquisition apparatus 20 has captured an IP packet. The control unit 33 determines an operating condition of each IP node based on the last communication time of each IP node. Specifically, the control unit 33 determines that the IP node whose last communication time has been updated during a predetermined period of time is in the operating condition. On the other hand, with respect to the IP node whose last communication time has not been updated during a predetermined period of time, the control unit 33 determines that the operating condition of the IP node is unclear. If the operating condition of the IP node is determined to be unclear, the control unit 33 makes an alive determination of the IP node using the communication in accordance with the ICMP in order to determine the operating condition of the IP node.

In the alive determination using the ICMP, the control unit 33 sends a request (ICMP Echo request) to the IP node whose last communication time has not been updated during a predetermined period of time, using the ICMP communication functional section 39. If the IP node to which the request has been sent is in the operating condition, the IP node sends a reply (ICMP Echo reply) to a source of the request, i.e. the management apparatus 30. When the reply is received, the control unit 33 of the management apparatus 30 determines that the IP node is in the operating condition.

On the contrary, if the IP node to which the request has been sent is not in the operating condition, the IP node cannot send the reply. Therefore, the management apparatus 30 does not receive the reply. In this case, the control unit 33 of the management apparatus 30 determines that the IP node is not in the operating condition.

In this manner, the management apparatus 30 checks the operating condition of each IP node by conducting the alive monitoring of each IP node.

Data requested or replied in accordance with the ID in the packet P1 may be data regarding the IP node whose last communication time has been updated during a predetermined period of time, data regarding the IP node whose last communication time has not been updated during a predetermined period of time, or a combination thereof. In any case, the control unit 33 sends the ICMP request to the IP node whose last communication time has not been updated during a predetermined period of time, among the IP node terminals from which IP packets are captured by the data acquisition apparatus 20.

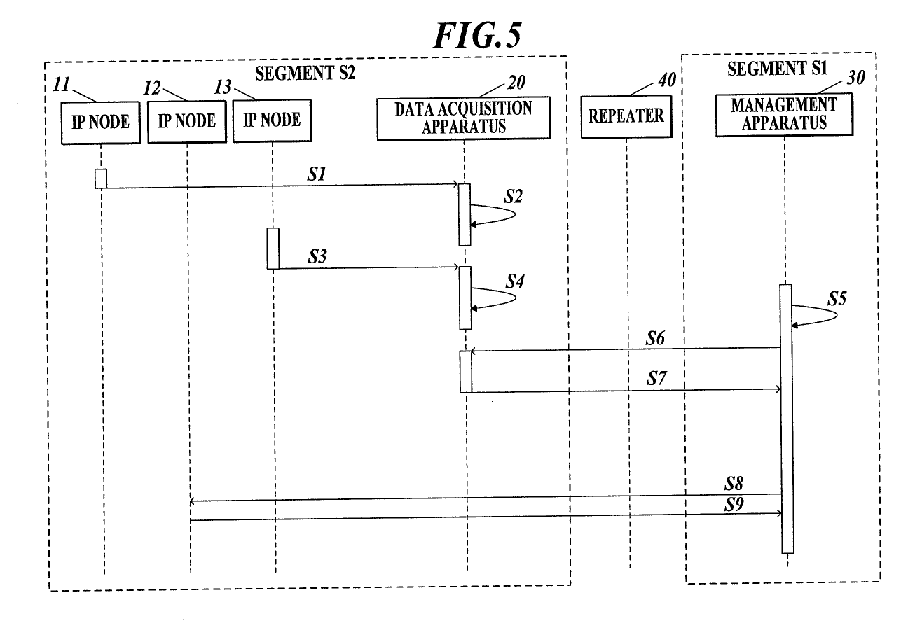

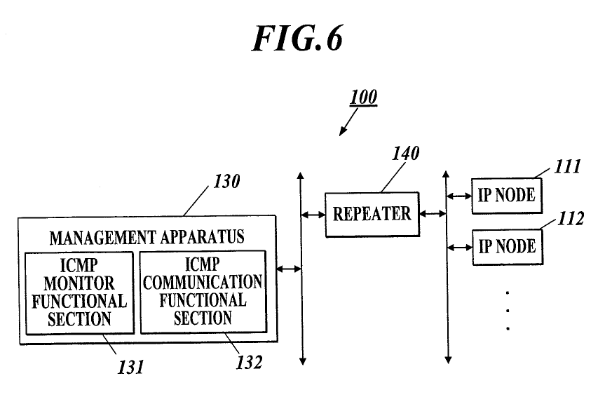

Next, an alive monitoring operation of each IP mode performed by the management apparatus 30 will be described with reference to a timing diagram of FIG. 5. In this example, packets are sent from the IP nodes 11 and 13 before step S6 (described later), and no packet is sent from the IP node 12.

When a packet is sent from the IP node 11 (step S1), the data acquisition apparatus 20 captures the packet sent in step S1 and stores receipt time of the packet into the last communication time table T1, as last communication time in an entry corresponding to an IP address of the IP node 11, or update the last communication time (step S2). Similarly, when a packet is sent from the IP node 13 (step S3), the data acquisition apparatus 20 captures the packet sent in step S3 and stores receipt time of the packet into the last communication time table T1, as last communication time in an entry corresponding to an IP address of the IP node 13, or update the last communication time (step S4).

The control unit 33 of the management apparatus 30 conducts alive monitoring of each IP node according to a predetermined schedule which is managed by the IP packet capture monitor functional section 35. First, the control unit 33 reads out the IP node alive monitoring probe correspondence table T2 in the correspondence data storage unit 32 and specifies a data acquisition apparatus which captures an IP packet of each IP node (step S5). Step S5 may be performed at any timing before step S6. For example, step S5 may be performed before steps S1 to S4, after thereof, or during thereof.

After step S5, the control unit 33 sends a request to the data acquisition apparatus 20 using the SNMP communication functional section 38 according to a predetermined schedule (step S6). That is, the control unit 33 sends the packet P1 to the data acquisition apparatus 20. The control unit 23 of the data acquisition apparatus 20 stores data indicating that there has been transmission from the IP nodes 11 and 13, into the packet P1, and sends the packet P1 to the management apparatus 30 (step S7). The data stored in step S7 corresponds to data requested by ID of the data D in the packet P1. Examples of the data requested by ID includes last communication time of each IP node and information indicating an IP node whose last communication time has been updated during a predetermined period of time.

The control unit 33 of the management apparatus 30 determines that the IP nodes 11 and 13 are in the operating condition and the operating condition of the IP node 12 is unclear, based on the reply in step S7. The control unit 33 sends a request (ICMP Echo Request) to the IP node 12 using the ICMP communication functional section 39 (step S8). If the IP node 12 is in the operating condition, the IP node 12 sends a reply (ICMP Echo reply) to the management apparatus 30 (step S9). When the reply in step S9 is received, the control unit 33 of the management apparatus 30 determines that the IP node 12 is in the operating condition. On the contrary, if the IP node 12 is not in the operating condition, no reply is sent in step S9, and thus, the control unit 33 determines that the IP node is not in the operating condition.

According to the above embodiments, the data acquisition apparatus 20 stores the last communication time of each IP node in the storage unit 22, and the management apparatus 30 checks the operating condition of each IP node based on the last communication time. At this time, the control unit 33 of the management apparatus 30 determines that an IP node whose last communication time is within a predetermined period of time is in the operating condition, and the management apparatus 30 will not individually make an alive determination of the IP node afterward. Therefore, the individual alive determination will not be made to each IP node whose last communication time has been stored or updated by the management apparatus 30, so that no resources can be allocated for the alive determination. In addition, it is possible to greatly decrease the frequency of consumption of network resources due to the packets associated with the communication for the alive determination. That is, it is possible to solve a problem of a conventional network management system where service response or quality provided by each IP node may deteriorated due to communication processes associated with the alive monitoring. Accordingly, it is possible to reduce consumption of resources associated with management of the operating conditions of the IP nodes.

The control unit 33 of the management apparatus 30 sends a query to the data acquisition apparatus 20 for checking the operating condition of each IP node, obtains information on whether or not the last communication time has been updated during a predetermined period of time, based on a response from the data acquisition apparatus 20 to the query, and checks the operating condition of each IP node based on the information. Accordingly, it is possible for the management apparatus 30 to check the operating condition of each IP node at an arbitrary timing.

In addition, the control unit 23 of the data acquisition apparatus 20 receives data transmitted from each of the plurality of IP nodes (for example, IP nodes 11 to 13) and stores the latest receipt time of the data in the last communication time table T1, as a last communication time of an entry corresponding to an IP address of each IP node. Next, the control unit 23 of the data acquisition apparatus 20 responds with respect to each IP node which has been specified in a query from the control unit 33 of the management apparatus 30, based on the last communication time of the IP node, in response to the query. Accordingly, the data acquisition apparatus 20 can conduct alive monitoring of a plurality of IP nodes instead, so that it is possible to greatly reduce consumption of resources due to the alive monitoring of the IP nodes.

Assuming that data requested or replied in accordance with the ID in the packet P1 is data regarding the IP node whose last communication time has been updated during a predetermined period of time, the control unit 33 can determine that the operating condition of the IP node which is not contained in the replied data is unclear. On the other hand, assuming that the data requested or replied in accordance with the ID in the packet P1 is data regarding the IP node whose last communication time has not been updated during a predetermined period of time, the control unit 33 can determine that the operating condition of the IP node which is contained in the replied data is unclear.

The packet P1 in the query includes an ID corresponding to data to be requested and data D having a null value D1. The control unit 23 of the data acquisition apparatus 20 stores the data requested in accordance with the ID into the value D1 and sends a reply to the management apparatus 30. Since the data requested in accordance with the ID is shared by the data acquisition apparatus 20 and the management apparatus 30, the data acquisition apparatus 20 can identify the requested data.

Moreover, since the header H is followed by data D, it is possible to send a query including a plurality of IDs with a single header H. Accordingly, as compared with when a single header H is provided for one piece of data D, data volume can be reduced. Therefore, it is possible to greatly reduce consumption of network resources.

In addition, in the query for the alive monitoring, the communication between the management apparatus 30 and the data acquisition apparatus 20 is performed according to the SNMP protocol, so that it is possible to reduce consumption of resources associated with the management of the operating conditions of the IP nodes without implementation of a privately-defined communication protocol.

Moreover, the control unit 33 of the management apparatus 30 individually makes an alive determination of each IP node whose last communication time has not been updated during a predetermined period of time, based on a response from the data acquisition apparatus 20 to the query using the packet P1. Accordingly, it is possible to accurately determine the operating condition of the IP node whose operating condition has been unclear.

The management apparatus 30 includes the correspondence data storage unit 32 which stores data indicating the correspondence between an IP node and a data acquisition apparatus 20 which receives data of the IP node (for example, an IP node alive monitoring probe correspondence table T2). The management apparatus 30 sends a query to the data acquisition apparatus associated with the IP node on which the alive monitoring is to be conducted. Accordingly, the management apparatus 30 can specify the data acquisition apparatus 20 to which the query is to be sent when conducting the alive monitoring of each IP node, so that it is possible to efficiently conduct the alive monitoring.

It is understood that the foregoing detailed description is exemplary and explanatory only and is not restrictive of the invention, as claimed. It is intended that the present invention covers modifications and variations that come within the scope of the appended claims and their equivalents.

For example, data communication having configurations corresponding to the packet p1 shown in FIG. 4 may be performed according to a privately-defined protocol. In addition, data configurations different from that of the data communication shown in FIG. 4 may be used to send a query for the alive monitoring of each IP node and to make a response based on the newest receipt time at which the data acquisition apparatus receives data from each IP node.

The above-described protocols in the embodiments are exemplary, and other protocols having the same functions may be employed.

In addition, functions which are executed as software processes by the control unit in the embodiments may be executed by a dedicated apparatus for each function or a dedicated apparatus having a plurality of functions.

In addition, each of the above-described configurations and functions of the IP nodes, the IP node monitoring probe 20, the management apparatus 30, the repeater 40, or the like may be individually implemented by a single apparatus. Alternatively, each of the configurations and functions may be implemented by any combination of a plurality of apparatuses.

According to a first aspect of the preferred embodiments of the present invention, there is provided a network management system, including: a data acquisition apparatus to receive data sent from each of a plurality of nodes to store at least latest receipt time of the data; and a management apparatus to check an operating condition of each of the nodes based on the latest receipt time stored in the data acquisition apparatus.

With this configuration, consumption of resources associated with management of operating conditions of nodes can be reduced.

Preferably, the management apparatus comprises a first control unit to send a query to the data acquisition apparatus for checking the operating condition of each of the nodes, obtain information on whether or not the latest receipt time has been updated during a predetermined period of time, based on a response from the data acquisition apparatus 20 to the query, and check the operating condition of each of the nodes based on the information.

Preferably, the data acquisition apparatus includes: a transceiver to receive at least the data sent from each of the nodes; a storage unit to store at least the latest receipt time of the data sent from each of the nodes; and a second control unit to respond to a query from the management apparatus for checking an operating condition of a specified at least one of the plurality of nodes, based on the latest receipt time corresponding to the specified at least one of the plurality of nodes.

Preferably, the second control unit responds with respect to at least one of the nodes that the latest receipt time has been updated during a predetermined period of time, and/or with respect to at least one of the nodes that the latest receipt time has not been updated during a predetermined period of time, in response to the query.

According to a second aspect of the preferred embodiments of the present invention, there is provided a data acquisition apparatus which is to be connected to a plurality of nodes and a management apparatus that checks an operating condition of each of the nodes, the data acquisition apparatus, including: a transceiver to receive at least data sent from each of the nodes; a storage unit to store at least latest receipt time of the data sent from each of the nodes; and a control unit to respond to a query from the management apparatus for checking an operating condition of a specified at least one of the plurality of nodes, based on the latest receipt time corresponding to the specified at least one of the plurality of nodes.

Preferably, the control unit responds with respect to at least one of the nodes that the latest receipt time has been updated during a predetermined period of time, and/or with respect to at least one of the nodes that the latest receipt time has not been updated during a predetermined period of time, in response to the query.

According to a third aspect of the preferred embodiments of the present invention, there is provided a method for checking an operating condition of each of a plurality of nodes, the method including: receiving, by a data acquisition apparatus, data sent from each of the plurality of nodes to store at least latest receipt time of the data in the data acquisition apparatus; and checking, by a management apparatus, the operating condition of each of the nodes, based on the latest receipt time stored in the data acquisition apparatus.

The entire disclosure of Japanese Patent Application No. filed on Jun. 19, 2008 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A network management system, comprising:
a data acquisition apparatus to receive data sent from each of a plurality of nodes to store at least latest receipt time of the data; and
a management apparatus to check an operating condition of each of the nodes based on the latest receipt time stored in the data acquisition apparatus.

2. The network management system according to claim 1, wherein
the management apparatus comprises a first control unit to send a query to the data acquisition apparatus for checking the operating condition of each of the nodes, obtain information on whether or not the latest receipt time has been updated during a predetermined period of time, based on a response from the data acquisition apparatus 20 to the query, and check the operating condition of each of the nodes based on the information.

3. The network management system according to claim 1, wherein
the data acquisition apparatus comprises:
a transceiver to receive at least the data sent from each of the nodes;
a storage unit to store at least the latest receipt time of the data sent from each of the nodes; and
a second control unit to respond to a query from the management apparatus for checking an operating condition of a specified at least one of the plurality of nodes, based on the latest receipt time corresponding to the specified at least one of the plurality of nodes.

4. The network management system according to claim 3, wherein
the second control unit responds with respect to at least one of the nodes that the latest receipt time has been updated during a predetermined period of time, and/or with respect to at least one of the nodes that the latest receipt time has not been updated during a predetermined period of time, in response to the query.

5. A data acquisition apparatus which is to be connected to a plurality of nodes and a management apparatus that checks an operating condition of each of the nodes, the data acquisition apparatus, comprising:
a transceiver to receive at least data sent from each of the nodes;
a storage unit to store at least latest receipt time of the data sent from each of the nodes; and
a control unit to respond to a query from the management apparatus for checking an operating condition of a specified at least one of the plurality of nodes, based on the latest receipt time corresponding to the specified at least one of the plurality of nodes.

6. The data acquisition apparatus according to claim 5, wherein
the control unit responds with respect to at least one of the nodes that the latest receipt time has been updated during a predetermined period of time, and/or with respect to at least one of the nodes that the latest receipt time has not been updated during a predetermined period of time, in response to the query.

7. A method for checking an operating condition of each of a plurality of nodes, the method comprising:
receiving, by a data acquisition apparatus, data sent from each of the plurality of nodes to store at least latest receipt time of the data in the data acquisition apparatus; and
checking, by a management apparatus, the operating condition of each of the nodes, based on the latest receipt time stored in the data acquisition apparatus.
